(19) United States
(12) Patent Application Publication
(10) Pub. No.: US 2014/0018994 A1
(43) Pub. Date: Jan. 16, 2014

(54) Drive-Control Systems for Vehicles Such as Personal-Transportation Vehicles

(71) Applicants: Thomas A. Panzarella, Philadelphia, PA (US); John R. Spletzer, Center Valley, PA (US)

(72) Inventors: Thomas A. Panzarella, Philadelphia, PA (US); John R. Spletzer, Center Valley, PA (US)

(21) Appl. No.: 13/940,301

(22) Filed: Jul. 12, 2013

Related U.S. Application Data
(60) Provisional application No. 61/671,390, filed on Jul. 13, 2012.

(51) Int. Cl. G05D 1/02

(52) U.S. Cl. CPC G05D 1/0212
USPC 701/25

(57) ABSTRACT

Drive-control systems for personal-transportation vehicles can function as active driving aids that enable autonomous and semi-autonomous cooperative navigation of electric-powered wheelchairs (EPWs) and other vehicles both indoors, and in dynamic, outdoor environments. The systems can help to compensate for the loss of cognitive, perceptive, or motor function in the driver by interpreting the driver's intent and seeing out into the environment on the driver's behalf. The systems can incorporate intelligent sensing and drive-control means that work in concert with the driver to aid in negotiating changing terrain, avoiding obstacles/collisions, maintaining a straight trajectory, etc. In addition, the systems can be configured to facilitate higher-level path planning, and execution of non-linear routes of travel in a safe and efficient manner.

### CROSS-REFERENCE TO RELATED APPLICATIONS

This application claims the benefit under 35 U.S.C. 119(e) of U.S. Application No. 61/671,390, filed Jul. 13, 2012, the contents of which are incorporated by reference herein in their entirety.

### BACKGROUND

1. Statement of the Technical Field

The inventive concepts disclosed herein relate to drive-control systems that can facilitate autonomous and semi-autonomous movement and navigation of vehicles, such as personal-transportation vehicles, in response to user inputs.

2. Description of Related Art

Personal-transportation vehicles, such as electric-powered wheelchairs (EPWs), are widely used by individuals with ambulatory difficulties resulting from advanced age, physical injury, illness, etc. The use of EPWs by seniors and others with ambulatory difficulties can be a significant step in helping such people maintain independent mobility, which can facilitate living at home or in a minimal-care setting.

Most EPWs, however, operate with differential steering that responds directly to physical inputs from the user. Thus, the user must continually provide physical inputs to steer and otherwise navigate the EPW along the desired direction of travel, and around obstacles. These physical inputs are typically generated using joysticks, sip-and-puff devices, chin controls, switches, etc. Providing the physical inputs necessary to negotiate changing terrain, avoid obstacles, or maintain a straight path or trajectory, however, can be challenging for mobility-impaired individuals, who often have limited cognitive, perceptive, and/or motor functions. Moreover, traditional joystick users with impaired hand-control, and those who rely on “latched driving” modes, such as cruise control, for independence and function may require additional assistance to ensure safe and comfortable mobility.

### SUMMARY

Drive-control systems for personal-transportation vehicles can function as active driving aids that enable autonomous and semi-autonomous cooperative navigation of EPWs and other vehicles both indoors, and in dynamic, outdoor environments. When configured for use with EPWs, the systems can generally be operated by EPW users of nearly all ages, are independent of make and model of EPW, and can integrate with a broad array of primary input devices, e.g., traditional joysticks, sip-and-puff devices, switch driving systems, chin controls, or short-throw joysticks. The systems can help to compensate for the loss of cognitive, perceptive, or motor function in the driver by interpreting the driver's intent and seeing out into the environment on the driver's behalf. The systems can incorporate intelligent sensing and drive-control means that work in concert with the driver to aid in negotiating changing terrain, avoiding obstacles and collisions, maintaining a straight path, etc. In addition, the systems can be configured to facilitate higher-level path planning, and execution of non-linear routes of travel in a safe and efficient manner.

Drive-control systems for vehicles include an input device operable to generate an output representative of a desired direction of travel of the vehicle based on an input from a user of the vehicle, and a computing device communicatively coupled to the input device. The computing device has a processor, a memory communicatively coupled to the processor, and computer-executable instructions stored at least in part on the memory.

The computer-executable instructions are configured so that the computer-executable instructions, when executed by the processor, cause the processor to: generate multiple proposed trajectories generally aligned with the desired direction of travel; choose one of the proposed trajectories based on one or more predetermined criteria; and generate an output that, when received by the vehicle, causes the vehicle to travel along the chosen trajectory.

Vehicles include a chassis; one or more wheels coupled to the chassis and configured to rotate in relation to the chassis; and one or more motors operable to cause the one or more wheels to rotate. The vehicles further include a drive-control system having an input device operable to generate an output representative of a desired direction of travel of the vehicle based on an input from a user of the vehicle; and a computing device communicatively coupled to the input device and the motors. The computing device includes a processor, a memory that communicates with the processor, and computer-executable instructions stored at least in part on the memory.

The computer-executable instructions are configured so that the computer-executable instructions, when executed by the processor, cause the processor to: generate multiple proposed trajectories generally aligned with the desired direction of travel; choose one of the proposed trajectories based on one or more predetermined criteria; and generate an output that, when received by the one or more motors, selectively activates the motor or motors to cause vehicle to travel along the chosen trajectory.

### BRIEF DESCRIPTION OF THE DRAWINGS

Embodiments will be described with reference to the following drawing figures, in which like numerals represent like items throughout the figures and in which:

FIG. 1A is a perspective view of a rehabilitation technology system comprising a first type of EPW equipped with a drive-control system;

FIG. 1B is a perspective view of another rehabilitation technology system comprising a second type of EPW equipped with a drive-control system;

FIGS. 1C-1E are magnified views of a portion of the area designated “A” in FIG. 1B;

FIG. 2 is a block diagram depicting various electrical and mechanical components of an EPW and a drive-control system therefor; and

FIG. 3 is a block diagram depicting various hardware and software of the drive-control system shown in FIG. 2; and

FIG. 4 is a block diagram depicting a controller and other electrical components of the drive-control system shown in FIGS. 2 and 3.

### DETAILED DESCRIPTION

The inventive concepts are described with reference to the attached figures. The figures are not drawn to scale and they are provided merely to illustrate the instant inventive concepts. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts. The inventive concepts is not limited by the illustrated ordering of acts or events, as some acts may occur in different orders and/or concurrently with other acts or events. Furthermore, not all illustrated acts or events are required to implement a methodology in accordance with the inventive concepts. As used herein, the singular forms “a”, “an” and “the” are intended to include the plural forms as well, unless the context clearly indicates otherwise.

Systems for implementing cooperatively controlled, semi-autonomous drive-control of vehicles such as personal transportation vehicles are disclosed herein. The systems are described in connection with personal transportation vehicles, such as EPWs, for exemplary purposes only. The systems can be used to provide drive-control for other types of vehicles. For example, the systems can also be adapted for use with vehicles such as telepresence robots, golf carts, fork trucks, and other types of small industrial vehicles, disaster recovery and reconnaissance vehicles, lawn mowers, etc.

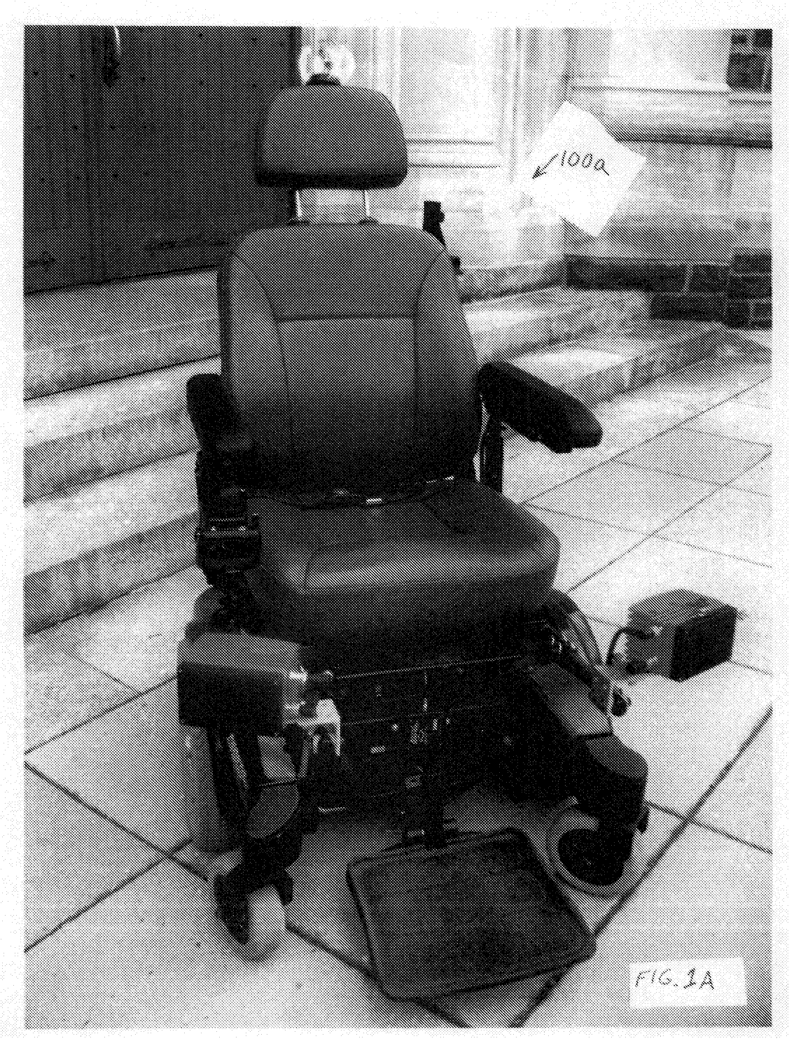

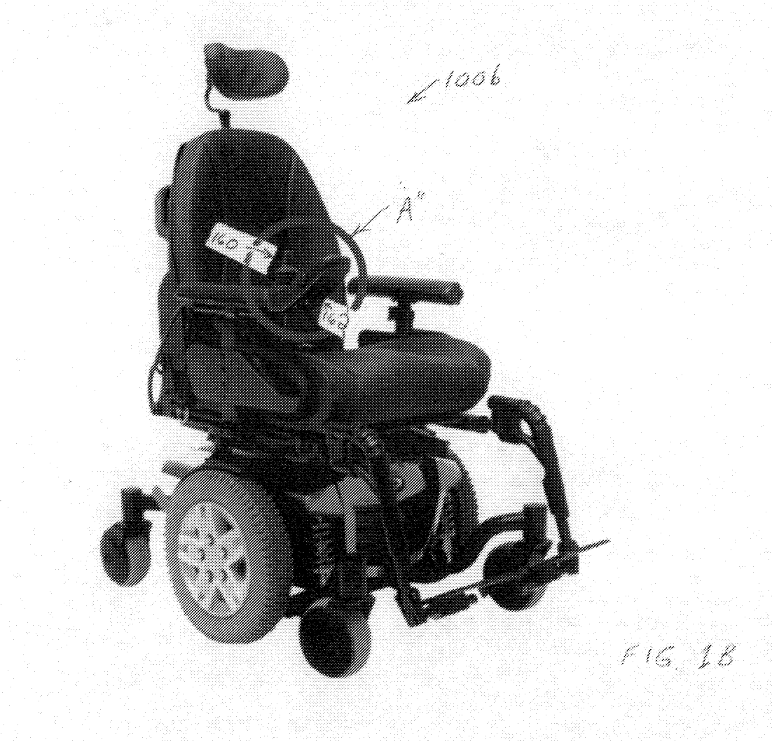

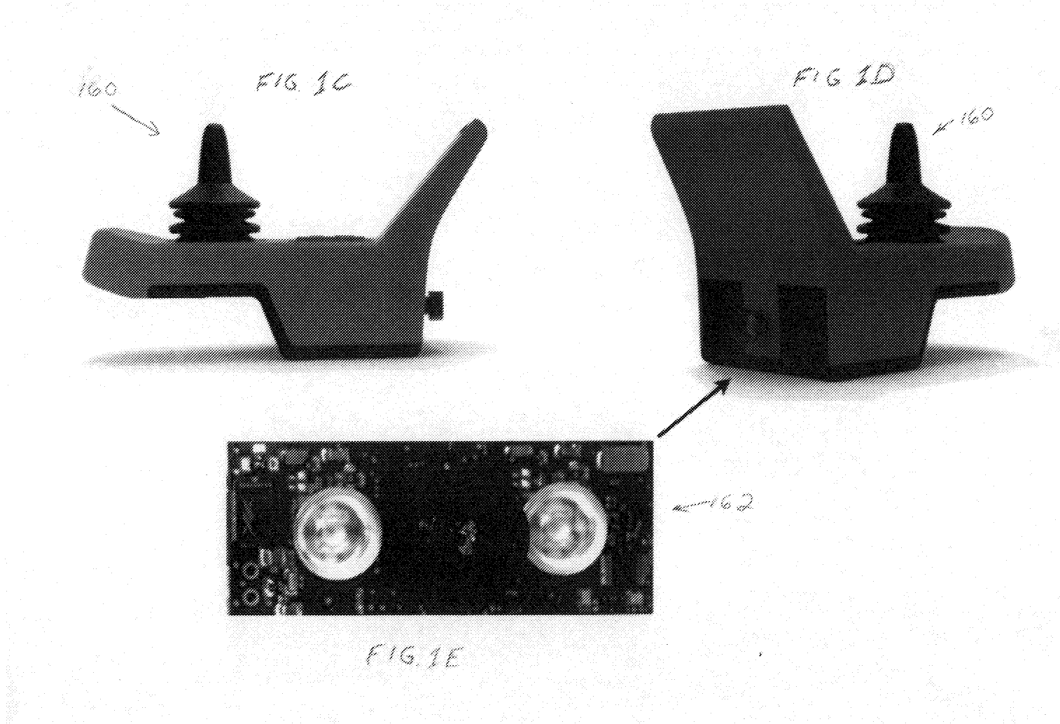

The drive-control systems can function as a component of a larger complex rehabilitation technology system. FIGS. 1A-1E depict two exemplary physical embodiments of the inventive drive-control systems integrated with an EPW to form rehabilitation technology systems. FIG. 1A depicts an embodiment of the inventive system comprising two IFM Efector O3D200 3D cameras integrated onto an Invacare Corp. EPW 100a. FIGS. 1B-1E depict another embodiment integrated with a Pride Mobility Products Corp. Quantum Q6 Edge EPW 100b. In this example, the primary joystick is replaced with a joystick 160, best shown in FIGS. 1C and 1D, that is enabled to interface with the inventive drive-control system. This embodiment also includes a wide field-of-view 3D camera 162, best shown in FIG. 1E, utilizing the same photonic mixer device (PMD) chip as the O3D200 camera. In both embodiments, additional on-board computation for the drive-control system is located in the battery compartment of the EPW, under its seat.

### System Hardware

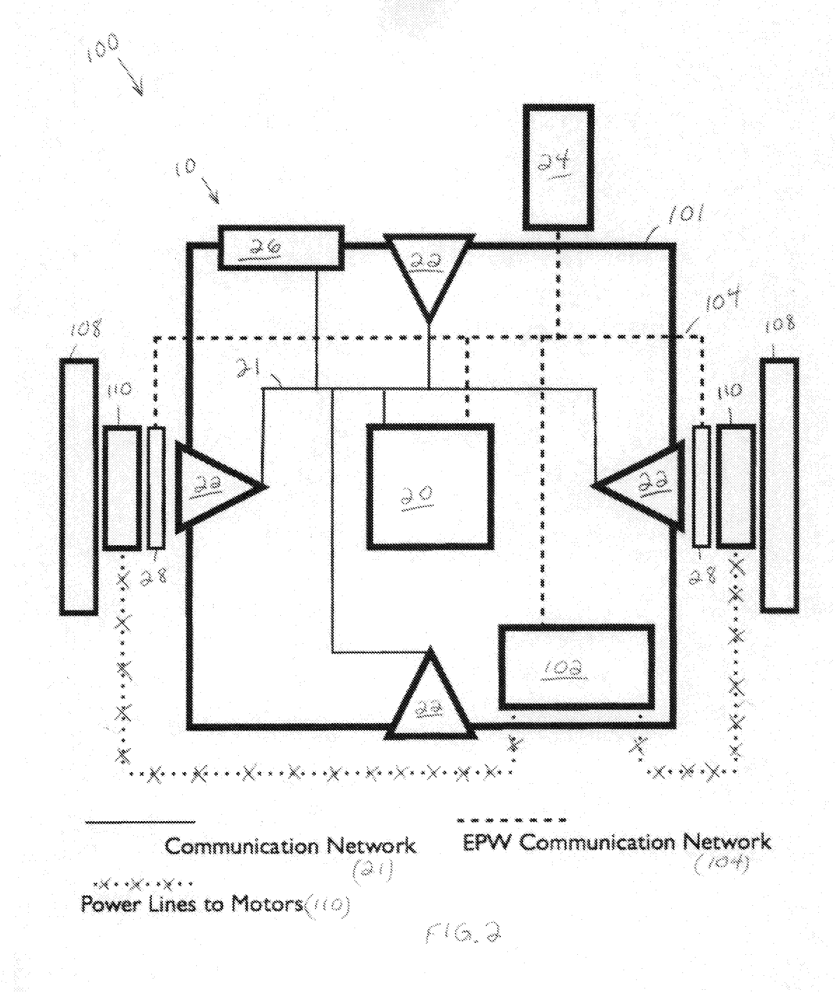

FIG. 2 depicts an exemplary embodiment of a drive-control system 10 in accordance with the inventive concepts disclosed herein. FIG. 2 also depicts various components of an EPW 100 into which the system 10 is integrated. The hardware of the drive-control system 10 is configured to be mounted to the existing chassis 101 of the EPW 100. The EPW 100 also includes a central computing device in the form of a controller 102, a communication network 104, left and right drive wheels 108, and left and right drive motors 110 associated with the respective left and right drive wheels 108. The drive motors 110 can be direct-current motors; other types of motors can be used in the alternative. The controller 102 regulates the electric power supplied to each drive motor 110 to control the operation thereof and thereby control the linear and angular displacement of the EPW 100.

The system 10 interfaces with the electronic subsystem of the EPW 100 via the existing communication network 104 of the EPW 100. In particular, the system 10 communicates with the EPW controller 102 via the communication network 104. The system 10 provides control inputs to the controller 102 via the communication network 104 so as to cause the controller 102 to actuate the drive motors 110 and thereby cause a desired movement of the EPW 100. In addition, the system 10 receives information from the controller 102, via the communication network 104, regarding the state of the EPW 100. The communication network 104 can be, for example, a controller area network (CAN) bus, as is common in EPWs such as the EPW 100.

The system 10 comprises a computing device 20, a communication network 21, a three-dimensional imaging system 22, a main input device 24, a rate-of-turn sensor 26, angular displacement sensors 28, and computer-executable instructions or software code 30.

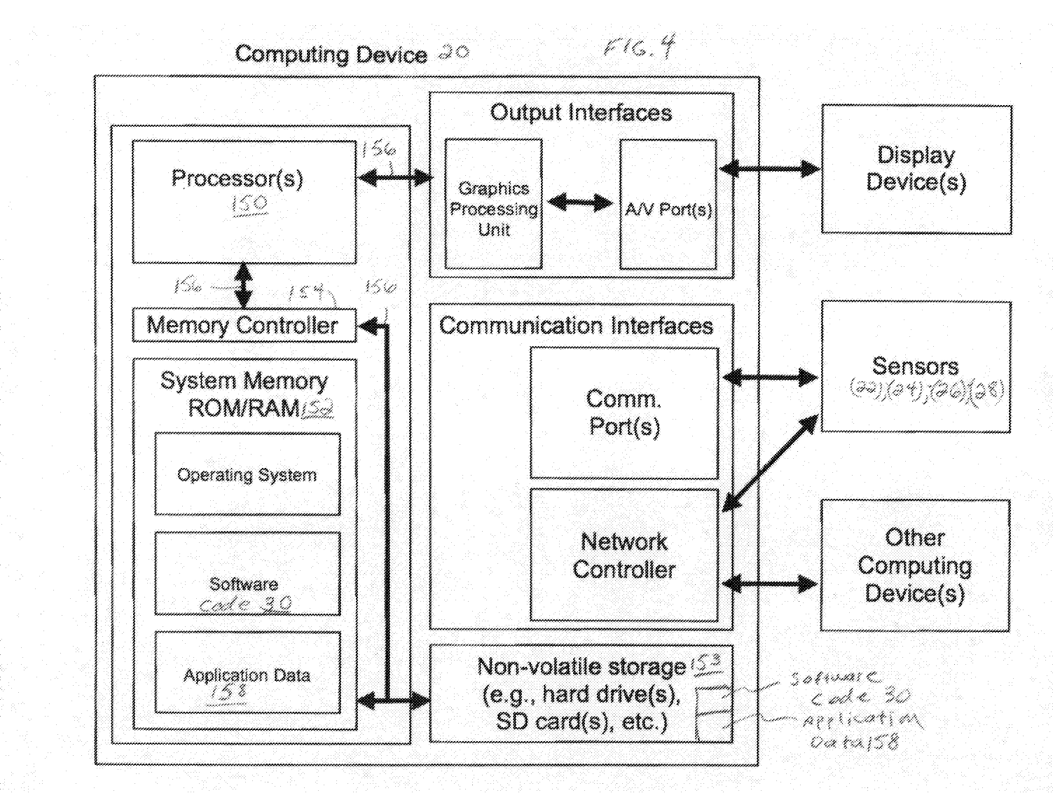

The computing device 20 is depicted in detail in FIG. 4. The computing device 20 includes a processor 150, such as a central processing unit (CPU), a system memory 152, non-volatile storage 153, and a memory controller 154 which communicate with each other via an internal bus 156. Portions of the software code 30 are permanently stored on the non-volatile storage 153, and are loaded into the system memory 152 upon startup of the system 10. Additionally, application data 158 is stored on the non-volatile storage 153, and is also loaded into the system memory 152 upon startup. Non-limiting examples of application data 158 include: calibration lookup tables used by the motor controller module; and customization parameters used to affect the behavior of the runtime system, e.g., max linear/angular velocity that should be output from the global planner module 52 (referenced below) of the drive-control system 10, etc.

The computing device 20 can include additional components such as output and communication interfaces (not shown). Those skilled in the art will appreciate that the system architecture illustrated in FIG. 4 is one possible example of a computing device 20 configured in accordance with the inventive concepts disclosed herein. The invention is not limited in this regard and any other suitable computer system architecture can also be used without limitation.

The computing device 20 accepts input from the various sensors on the system 10, interprets input from the primary input device of the user, i.e., the main input device 24, performs real-time calculations based on this input data and, via communication with the controller 102 of the EPW 100, actuates the drive motors 110 of the EPW 100 to effectuate the desired movement of the EPW 100. The computing device 20 communicates on both the communication network 21 of the system 10 and the communication network 104 of the EPW 100.

The communication network 21 facilitates communication between the various hardware components of the system 10. The communication network 21 can be, for example, a TCP/IP-based Ethernet network. The communication network 21 is a single communication network within the system 10. In alternative embodiments where multiple three-dimensional imaging systems 22 are used, the communication network 21 can be partitioned into multiple network segments to facilitate increased bandwidth between each imaging system 22 and the computing device 20. This feature can help accommodate the relatively large amount of data that is normally transferred to the computing device 20 from the imaging systems 22 during normal operation of the system 10.

The system 10 includes one imaging system 22 that faces toward the front of the EPW 100. As a result of this configuration, the system 10 is configured to limit its navigational planning and travel to only the forward direction. In order to drive in reverse, the system 10 causes the EPW 100 to rotate in place until its orientation is reversed, and then travel forward in its new orientation. Alternative embodiments of the system 10 can include more than one imaging system 22. For example, alternative embodiments can include four of the three-dimensional imaging systems 22 to facilitate a full 360° view of the surrounding environment, as depicted in FIG. 2. This configuration can facilitate reverse movement of the EPW 100, without a need to reverse the orientation thereof.

Representative systems that can be used as the three-dimensional imaging systems 22 include, for example, time-of-flight cameras based on the PMD Technologies gmbH Photonic Mixer Device (PMD) integrated circuit, such as the IFM Efector, Inc. O3D200 PMD three-dimensional sensor; structured light cameras based on the PrimeSense, Ltd. PS1080 System-on-a-Chip (SOC) such as the Microsoft Kinect; parallel light detection and ranging, or LIDAR, systems from Velodyne Lidar; and other active sensors capable of generating data that can be constructed into three-dimensional point clouds, including traditional two-dimensional LIDAR systems mechanically actuated to pan up-and-down resulting in the creation of three-dimensional images.

The main input device 24 is a proportional joystick. Other types of devices 24, including but not limited to sip-and-puff devices, switch input systems, head arrays, chin controls, etc., can be used as the main input device 24 in lieu of, or in addition to the proportional joystick. Input commands from the main input device 24 are digitized, and communicated over the communication network 104 of the EPW 100. Once available on the EPW communication network 104, the system 10 can interpret the signal from the main input device 24 for the purpose of navigating the EPW 100 in response to the user's input.

The rate-of-turn sensor 26 is mounted to the chassis 101 of the EPW 100. The rate-of-turn sensor 26 can be, for example, a gyroscope. Input from the rate-of-turn sensor 26 can be used by the system 10, for example, to correct for drift in the odometry estimates, or can be incorporated into a closed-loop control system for regulating the angular velocity of the EPW 100 during movement thereof.

Each angular displacement sensor 28 can be mounted on the output shaft of an associated one of the drive motors 110 of the EPW 100. The angular displacement sensors 28 can be, for example, quadrature encoder assemblies from which the angular displacement, and by inference the velocity and acceleration, of the associated wheel 108 of the EPW 100 can be determined.

### System Software

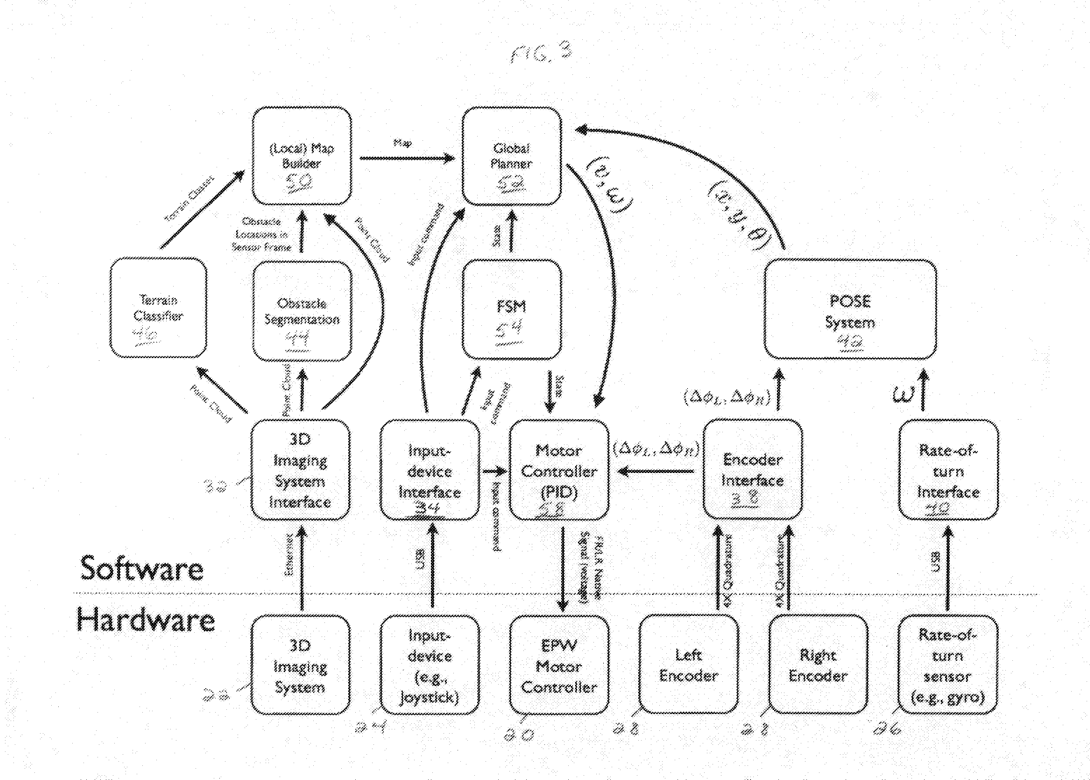

The computer-executable instructions or software code 30 of the system 10 can be organized into a loosely-coupled set of modules that interact with each other asynchronously. Although the modules interact asynchronously, each module meets its own strict timing constraints as needed, based on the role it plays within the system 10. FIG. 3 is a logical-interaction diagram outlining each of the major components of an exemplary embodiment of the software code 30. As can be seen in FIG. 3, the software code 30 includes the following modules: an imaging-system interface module 32; an input-device interface module 34; an angular position module 38; an angular velocity module 40; a position and orientation, or “POSE” module 42; an obstacle segmentation module 44; a terrain classifier module 46; a local map builder module 50; a global planner module 52; a finite state machine (FSM) module 54; and a motor controller module 58.

The imaging-system interface module 32 comprises a hardware driver for the three-dimensional imaging system 22. The imaging-system interface module 32 communicates with the three-dimensional imaging system 22 over the communication network 21 using a TCP/IP over Ethernet protocol, and publishes its acquired data stream as a three-dimensional point cloud for the other software modules of the system 10 to subscribe to. In alternative embodiments, communication between the central processor 20 and the three-dimensional imaging system 22 may be via other communication buses such as USB.

As discussed above, the main input device 24 of the system 10 is a proportional joystick. The joystick provides the primary user input to the system 10. The input-device interface module 34 implements a hardware driver for the joystick via the EPW communication network 104. The joystick interface module 34 publishes the joystick state to the rest of the system 10 via the communication network 21. The joystick state may include the relative stroke of the joystick, the state of any integral buttons, etc. In alternative embodiments in which the main input device 24 is a device other than a joystick, e.g., a head array, similar principles apply.

The angular position module 38 comprises a hardware driver for the angular displacement sensors 28. The angular position module 38 samples the state of the sensors 28 at, for example, 50 Hz. The angular position module 38 publishes the change in the angular position of the associated drive wheel 108, “Δφ,” to the rest of the system 10 via the communication network 21.

The angular velocity module 40 comprises a hardware driver for the rate-of-turn sensor 26. The angular velocity module 40 samples the state of the rate of turn sensor 26 at, for example, 50 Hz, and publishes the instantaneous angular velocity, i.e., rate-of-rotation, of the chassis 101 of the EPW 100 to the rest of the system 10 via the communication network 21.

The POSE module 42; obstacle segmentation module 44; terrain classifier module 46; local map builder module 50; global planner module 52; FSM module 54; and motor controller module 58 are stored in the non-volatile storage 153 of the computing device 20, and are executed by the processor 150.

The POSE module 42 is configured to take input from the angular position module 38 and the angular velocity module 40, and use that information to estimate the position and orientation of the EPW 100 with respect to an initial seeded value in a local coordinate frame.

The obstacle segmentation module 44 subscribes to the point cloud data published by the imaging-system interface module 32, via the communication network 21. The obstacle segmentation module 44 generates an estimate for the ground plane based on a priori knowledge of where the three-dimensional imaging system 22 is mounted in relation to the chassis 101 of the EPW 100. With a reliable estimate of the ground plane, the obstacle segmentation module 44 can segment positive and negative obstacles. Positive obstacles are those which rise above the ground plane, e.g., a chair, and negative obstacles are those below the ground plane, e.g., a downward flight of stairs.

The terrain classifier module 46 subscribes to the point cloud data published by the imaging-system interface module 32, via the communication network 21. Based on the remission data for each point in the point cloud and a similar ground plane estimation, an approach used in the obstacle segmentation module 44, the terrain classifier module 46 labels each point that lies on the ground plane as representing a particular terrain, e.g., sidewalk, asphalt, grass, etc. This classification is based on inference from a training set of data preloaded into the computer-readable storage medium 58 of the controller 20. The labeled points on the ground can then be used to implement various driving rules based on system-level configuration, e.g., “prefer driving on sidewalks as opposed to grass,” etc. The terrain classifier module 46 is only active when the system 10 is operating in outdoor environments.

The local map builder module 50 assimilates the location of obstacles, terrain, and other points in the point cloud data into a two-dimensional occupancy grid representation of a map. Grid cells are labeled as either “free” or “occupied” based on the presence of obstacles and the drivability of the detected terrain.

The global planner module 52 takes as input: (i) the occupancy grid from the local map builder module 50; (ii) the current position and orientation of the EPW 100 from the POSE module 42; (iii) the current mode of the system 10 from the FSM module 54; and (iv) the input from the main input device 24, i.e., the joystick, which as discussed above represents the desired direction of travel of the EPW 100. Based on these inputs, the global planner module 52 rolls out potential paths or trajectories, over a pre-configured time horizon, that the EPW 100 can potentially travel within the constraints of its kinematic model. Hundreds of potential trajectories generally aligned with the desired direction of travel may be considered. For each rolled-out trajectory, an associated cost function is calculated. The cost function takes into consideration the presence of obstacles on the path of that proposed trajectory; the smoothness-of-ride, i.e., minimizing angular accelerations; preference to drive straight; drivability of terrain; and other configurable parameters. The trajectory with the lowest associated cost is chosen as the path of travel within the map. The global planner module 46 generates an output in the form of linear and angular velocities (v, ω) that will cause the EPW 100 to drive along the selected trajectory. A new trajectory is selected at each time step.

The FSM module 54 implements a finite state machine to affect the behavior of the system 10. The states of the FSM are directly related to mode of operation of the system 10 (discussed further below). The states determine the level of autonomy of the system 10. The state is chosen by the user, via the primary input device 24. The FSM module 54 publishes the current state to the rest of the software 30, thus allowing the consuming software modules to modify their behavior as appropriate.

The motor controller module 58 functions as a proportional, integral, derivative (PID) controller that regulates the velocity of the chassis 101 of the EPW 100. The motor controller module 58 is the direct interface between the system 10 and the electronics of the EPW 100. The motor controller module 58 a closed loop system that takes an input from the angular position module 38 to estimate the current linear and angular velocity of the EPW 100, and regulates the linear and angular velocities of the EPW 100 to the (v, ω) set point input to the controller module 58 from the global planner module 52. In alternative embodiments, the motor controller module 58 can receive an additional input from the angular velocity module 40. Additionally, an emergency stop (ESTOP) command from the joystick interface module 34 (assumed to be initiated by the user) can be sent directly to the motor controller module 58 to cause the EPW 100 to stop with minimal latency.

### Operating Modes

The system 10 can operate in four major modes, and two minor modes. This effectively facilitates eight different modes of operation, as each major mode will operate in conjunction with one of the two minor modes, i.e., at all times the system 10 will be operating under the parameters of one major and one minor mode of operation.

The particular mode of operation is selected by the user via the primary input device 24. All major EPW manufacturers provide various “drive profiles” used to customize how their EPWs will behave based on where the user is currently operating the EPW. Typical drive profiles would include “indoor moderate mode”, “outdoor fast mode,” etc. Most EPW controllers allow for four to five drive profiles.

The selectable drive profiles of the EPW 100 can be configured to correspond to the various combinations of major and minor modes of the system 10. Thus, during operation, the system 10 will occupy one of the available drive profiles, and the system 10 will thereby be configured to operate in the particular combination of major and minor modes corresponding to the specific drive profile selected by the user. For example, a user may select Drive Profile 4 to enable the system 10 to operate in “indoor” (minor mode) with “supervised driving assistant” (major mode).

The minor modes of operation are “indoor” and “outdoor.” The terrain classifier module 46 is active when the system 10 is operating in the outdoor mode. As discussed above, the terrain classifier module 46 labels each point on the estimated ground plane as a particular terrain class. For example, when configuring the system 10 for use, it may be desirable to program the system 10 to recognize driving on grass as a prohibited behavior. Extending this example, once the local map builder module 50 has been given all terrain labels for each point on the ground plane by the terrain classifier module 46, the local map builder module 50 can consider those points labeled as grass “soft obstacles.” Once these particular points are considered obstacles, the global planner module 52 can develop a route of travel that keeps the EPW 100 off of the grass.

The terrain classifier module 46 is not active when the system 10 is operating in the indoor mode, and the system 10 will consider all points on the ground plane as valid terrain, i.e., as terrain suitable to be traversed by the EPW 100.

The system 10 is configured to operate in the following four major modes: “active braking;” “supervised driving assistant;” “adaptive cruise control;” and “semi-autonomous.”

The active braking mode provides the least amount of autonomy to the system 10. The active braking mode provides the user with nearly complete navigational control of the EPW 100 via the main input device 24, while maintaining the obstacle avoidance capabilities of the system 10 in the active state. This allows the system 10 to stop the EPW 100 in the event of an impending collision or a drop off in the surface upon which the EPW 100 is traveling, as recognized by the global planner module 52 operating in conjunction with the imaging system 22, obstacle segmentation module 44, and local map builder module 50. This mode of operation can be particularly beneficial, for example, to children, the elderly, and new EPW drivers.

The supervised driving assistant mode builds on top of the active braking mode described above. The supervised driving assistant mode allows the user to exercise nearly complete navigational control of the EPW 100 via user inputs provided through the main input device 24. In addition, the supervised driving assistant mode provides obstacle avoidance capabilities as discussed above in relation to the active braking mode. In addition, the supervised driving assistant mode facilitates “model aware” feature detection, and the generation and execution of optimized trajectory plans for navigating through the detected models. As an example, a user operating the EPW 100 in this mode may be approaching a recognizable model or geometric feature such as a narrow doorway. The obstacle segmentation module 44 is configured to recognize the doorway based on the input from the imaging system 22. The local map builder module 50 identifies the doorway through which the EPW 100 is to traverse, and classifies the doorway as such in the occupancy grid.

The global planner module 52 leverages both proprioceptive information and exteroceptive information, i.e., the occupancy grid from the local map builder module 50; the current position and orientation of the EPW 100 from the POSE module 42; the current mode of the system 10 from the FSM module 54; and the input from the main input device 24. Based on this information, the global planner module 52 plans a trajectory for the EPW 100 through the doorway, and generates linear and angular velocity (v, ω) set point inputs. These set point inputs, when sent to the EPW controller 102 via the motor controller module 58 and the communication network 104, effectuate movement of the EPW 100 along the planned trajectory through the doorway.

The system 10 is configured to recognize, and to automatically guide the EPW 100 through or around features other than doorways when operating in the supervised driving assistant mode. For example, the system 10 can be configured to recognize and provide automated guidance in relation to hallways, bathrooms, elevators, etc.

The adaptive cruise control mode is an extension to what is commonly referred to as latched driving. A latched driving system allows the user of the EPW 100 to set a desired cruise speed, and the EPW 100 will maintain a consistent speed and heading based on proprioceptive information gathered by the various sensors of the system 10, e.g., the angular displacement sensors 28, the rate-of-turn sensor 26, etc. The adaptive cruise control mode expands on the conventional latched-driving concept in at least two ways. First, when the system 10 is operating in the adaptive cruise control mode, the active braking capabilities of the system 10 are enabled so that the system 10 will cause the EPW 100 to autonomously stop in the face of a static positive or negative obstacle. This allows for a latched driving mode that will avoid collisions without requiring user input.

Second, the global planner module 52 will generate liner velocity set point inputs (v) that cause the EPW 100 to slow down as necessary to accommodate for moving/dynamic obstacles in order to avoid a collision. For example, the EPW 100 may be “cruising” behind a person who is walking at a speed slower than the linear velocity at which the EPW 100 is traveling. Rather than just stopping, or worse, colliding with the person, the global planner module 52 will generate an appropriate linear velocity (v) set point input that causes the EPW 100 to slow down so as to maintain a safe separation distance between the EPW 100 and the pedestrian.

The semi-autonomous mode builds on top of the adaptive cruise control mode by performing dynamic path planning Dynamic path planning provides the user of the EPW 100 with the ability to safely drive along non-linear routes of travel, which is a necessary capability in dynamic real-world environments. In the semi-autonomous mode, the system 10 works together with the user to facilitate independent mobility in which coarse-grained route planning is handled by the user, while fine-grained path planning and control, including obstacle avoidance, is effectuated automatically by the system 10.

Coarse-grained route planning is achieved through input cues received from the user via the main input device 24. For example, the user can generate an input cue for a left turn by momentarily moving the joystick of the main input device 24 to the left. In alternative embodiments where the main input device 24 is a head-array, for example, the user can generate the input cue by momentarily activating the left-side switch of the array with his or her head. Upon receiving the user input, the system 10 determines whether it is feasible for the EPW 100 to travel leftward, based on the suitability of the terrain and the absence of obstacles as recognized by the global planner module 52 operating in conjunction with the imaging system 22, obstacle segmentation module 44, and local map builder module 50 as discussed above.

Upon determining that leftward travel is feasible, the system 10 will perform fine-grained path planning and control to carry out that course of action. In particular, the system 10 will autonomously guide the EPW 100 using the path-planning features effectuated by the global planner module 52 as described above, i.e., the global planner module 52 will generate multiple proposed trajectories that the EPW 100 could travel within the constraints of its kinematic model, chooses the trajectory with the lowest associated “cost,” and generates input velocity set points that, when received by the controller 102 of the EPW 100, cause the EPW 100 to travel along the chosen trajectory.

Continuing with the example of leftward travel, the system 10 will maintain travel in the commanded direction until the user provides an updated input cue. The user can change the course of travel by momentarily moving the joystick of the main input device 24 toward a new direction of travel. The user can stop the EPW 100 by momentarily moving the joystick rearward. In addition, the system 10 will cause the EPW 100 to stop moving in the commanded direction of travel when the EPW 100 encounters an intersection or other obstacle that prevents continued travel in that direction.

The autonomous driving available in the semi-autonomous mode can be performed in a “greedy” or “conservative” manner. The greedy and conservative modes affect the response of the system 10 when the EPW 100 encounters an intersection or other obstacle that prevents it from continuing in the commanded direction of travel. The system 10, when configured in the conservative mode, will cause the EPW 100 to stop at the intersection and wait for a new user input under such circumstances, regardless of whether the only available option is to turn or otherwise move in only one direction.

When the system 10 is operating in the greedy mode and the EPW 100 reaches an intersection or other obstacle where the only available option is to turn or otherwise move in only one direction and continue driving, the global planer module 52 will autonomously make the decision to turn or move the EPW 100 in that direction. The global planer module 52 will generate set point inputs, as discussed above, that cause the EPW 100 to move in that direction and continue such movement until another obstacle is encountered, or the user provides another input.

If the possible course of travel has more than one option, e.g., where the EPW 100 encounters a T-shaped intersection, the system 10 will require the user to choose which direction to turn via a momentary input cue provided through the main input device 24. The global planer module 52 will consider this direction to be a new course to be followed, and will generate set point inputs that cause the EPW 100 to move in that direction, and to continue such movement until another obstacle is encountered, or the user provides another input.

As discussed above, the systems described herein can be applied to vehicles other than EPWs. In vehicles that incorporate differential steering, such as the EPW 100, the system 10 as described herein can be used without any substantial modification. In vehicles that incorporate steering based on other kinematic models, the system 10 can be reconfigured by simply replacing the motor controller module 58 of the software code 30 with motor-controller software tailored to the new kinematic model. This is possible because the global planner module 52 outputs linear and angular velocities (v, ω) as set points to the motor controller module 58, and the motor controller module 58 translates these set points into the particular output control signals required to move the EPW 100 or other vehicle along the desired trajectory. For example, the system 10 can be tailored for use with a golf cart that utilizes Ackerman steering by plugging an appropriate kinematic model into the motor controller module 58 so that the motor controller module 58 outputs accelerator position and steering wheel angle based on the v, ω set points it receives from the global planner module 52, to achieve the feasible trajectories generated by the global planner module 52.

What is claimed is:

1. A drive-control system for a vehicle, comprising:
an input device operable to generate an output representative of a desired direction of travel of the vehicle based on an input from a user of the vehicle; and
a computing device communicatively coupled to the input device, the computing device comprising a processor, a memory communicatively coupled to the processor, and computer-executable instructions stored at least in part on the memory; wherein the computer-executable instructions are configured so that the computer-executable instructions, when executed by the processor, cause the processor to:
generate multiple proposed trajectories generally aligned with the desired direction of travel;
choose one of the proposed trajectories based on one or more predetermined criteria; and
generate an output that, when received by the vehicle, causes the vehicle to travel along the chosen trajectory.

2. The system of claim 1, wherein the one or more predetermined criteria include avoidance of obstacles; smoothness-of-ride, preference for a straight trajectroy; and drivability of ground terrain.

3. The system of claim 1, wherein the output comprises set points representative of linear and angular velocities of the vehicle.

4. The system of claim 1, further comprising an imaging system communicatively coupled to the processor, the imaging system being operable to generate an output representative of an image of the ground and other surroundings of the vehicle.

5. The system of claim 4, wherein the output of the imaging system is a three-dimensional point cloud.

6. The system of claim 4, further comprising a rate-of-turn sensor communicatively coupled to the processor, the rate-of-turn sensor being operable to generate an output representative of a rate of rotation of the vehicle.

7. The system of claim 6, further comprising an angular displacement sensor communicatively coupled to the processor, the angular displacement sensor being operable to generate an output representative of an angular displacement of a wheel of the vehicle.

8. The system of claim 7, wherein the computer-executable instructions are further configured so that the computer-executable instructions, when executed by the processor, cause the processor to estimate a position and an orientation of the vehicle based at least in part on the outputs of the rate-of-turn sensor and the angular displacement sensor.

9. The system of claim 8, wherein the computer-executable instructions are further configured so that the computer-executable instructions, when executed by the processor, cause the processor to generate an estimate for a ground plane proximate the vehicle, and to segment one or more obstacles on or below the estimated ground plane.

10. The system of claim 9, wherein the computer-executable instructions are further configured so that the computer-executable instructions, when executed by the processor, cause the processor to recognize the type of ground terrain proximate the vehicle.

11. The system of claim 10, wherein the computer-executable instructions are further configured so that the computer-executable instructions, when executed by the processor, cause the processor to generate a two-dimensional occupancy grid for the vehicle based at least in apart on locations of the obstacles and the type of ground terrain.

12. The system of claim 11, wherein the computer-executable instructions generate the multiple proposed trajectories generally aligned with the desired direction of travel based at least in part on the occupancy grid; the output of the input device; and the position and orientation of the vehicle.

13. The system of claim 12, wherein the output of the processor causes one or more drive motors of the vehicle to activate to cause the vehicle to travel along the chosen trajectory.

14. The system of claim 1, wherein the computer-executable instructions are further configured so that the computer-executable instructions, when executed by the processor, cause the processor to generate another output that, when receive by the vehicle, causes the vehicle to move at a substantially constant speed and heading.

15. The system of claim 14, wherein the computer-executable instructions are further configured so that the computer-executable instructions, when executed by the processor, cause the processor to generate an estimate for a ground plane proximate the vehicle; to segment one or more obstacles on or below the estimated ground plane; and to generate another output that, when received by the vehicle while the vehicle is moving at the substantially constant speed and heading, further causes the vehicle to stop and/or slow to avoid colliding with the one or more obstacles.

16. The system of claim 1, wherein the computer-executable instructions are further configured so that the computer-executable instructions, when executed by the processor, cause the processor to recognize one or more predetermined geometric features, and to generate another output that, when received by the vehicle, causes the vehicle to travel through or around the one or more geometric features.

17. The system of claim 1, wherein the input from the user to the input device is a momentary movement of a portion of the input device in a direction corresponding to the desired direction of travel.

18. The system of claim 1, wherein the computer-executable instructions are further configured so that the computer-executable instructions, when executed by the processor, cause the processor to recognize when the vehicle reaches an intersection that prevents further travel along the chosen trajectory; to determine whether there is only one possible direction of travel through the intersection; and if there is only possible direction of travel through the intersection, to generate a further output that, when received by the vehicle, causes the vehicle to travel in the one possible direction of travel through the intersection.

19. A vehicle, comprising:
a chassis;
one or more wheels coupled to the chassis and configured to rotate in relation to the chassis;
one or more motors operable to cause the one or more wheels to rotate; and
a drive-control system comprising an input device operable to generate an output representative of a desired direction of travel of the vehicle based on an input from a user of the vehicle; and a computing device communicatively coupled to the input device and the one or more motors, the computing device comprising a processor, a memory communicatively coupled to the processor, and computer-executable instructions stored at least in part on the memory; wherein the computer-executable instructions are configured so that the computer-executable instructions, when executed by the processor, cause the processor to: generate multiple proposed trajectories generally aligned with the desired direction of travel; choose one of the proposed trajectories based on one or more predetermined criteria; and generate an output that, when received by the one or more motors, selectively activates the one or more motors to cause vehicle to travel along the chosen trajectory.

20. The vehicle of claim 19, wherein the vehicle is a personal-transportation vehicle.
